(19) United States
(12) Patent Application Publication
(10) Pub. No.: US 2008/0189725 A1
(43) Pub. Date: Aug. 7, 2008

(54) Pickup unit

(76) Inventors: Rei Shukuya, Kawasaki-shi (JP); Kuniyuki Ishii, Matsudo-shi (JP)

Correspondence Address: CLARK & BRODY, 1090 VERMONT AVENUE, NW, SUITE 250, WASHINGTON, DC, 20005, US

(21) Appl. No.: 12/068,184

(22) Filed: Feb. 4, 2008

(30) Foreign Application Priority Data
Feb. 5, 2007 (JP) 2007-025092

(51) Int. Cl. G11B 17/03

(52) U.S. Cl. 720/613

(57) ABSTRACT

The present invention aims at providing a pickup unit that can freely select the mounting position of an adjusting screw for making tilt adjustment and facilitates the miniaturization and thinning. An energizing force in the tracking direction at the end of main guide is received by an adjusting plate, and the adjusting plate is apart from the unit substrate by fixing its one end to a unit substrate and bringing its other end into contact with a main guide, and providing a flexible part near the one end and a through-hole near the other end in an intermediate section.

### BACKGROUND OF THE INVENTION

1. Field of the Invention

The present invention relates to a pickup unit that can freely select the mounting position of an adjustment screw for making the tilt adjustment of a pickup guide, i.e., tilt adjustment of a pickup according to peripheral conditions and facilitates miniaturization and thinning.

2. Description of the Prior Art

A guide device of optical pickup has been described in Japanese Laid-Open Patent Publication No. 2003-352531. One end side of a guide shaft 2 is energized in the radial direction to a disc, the tracking direction and the third direction orthogonal to these two directions by a torsion coil spring 12, energizing forces in the tracking direction and the third direction are received by a first touching part 8, an energizing force in the radial direction is received by an inclined receiver 17 on the other end side of guide shaft 2, and a component force generated by the inclined receiver 17 in the third direction is received by a second touching part 9 on the other side of guide shaft 2.

However, no tilt adjustment of guide shaft 2, i.e., tilt adjustment of pickup has yet been described.

Tilt adjustment device of an optical disc player is described in Japanese Laid-Open Patent Publication No. 2004-71136. Adjustment ends 112, 121 of guide shafts 110, 120 for guiding an optical pickup 30 to make it movable to and fro are elastically pressed upward by elastic members 130, 140, and the tilt adjustment of optical pickup 30 is made possible by increasing or reducing the tightness of adjustment screws 150, 160 provided on the upper side.

Particularly, sections becoming the adjustment ends 112, 121 are formed by cutting the upper halves of guide shafts 110, 120, bottomed holes 114, 124 are provided at the cutting faces 116, 126 to bring the adjustment screws 150, 160 into contact with bottom surfaces of holes 114, 124 and lowly suppress the height of adjustment screws.

A mechanism holding a guide shaft 2 at a fixed position with a spring and a receiver in the guide device of an optical pickup is shown in Japanese Laid-Open Patent Publication No. 2002-352531, but there is no description on tilt adjustment.

In the pickup unit disclosed in Japanese Laid-Open Patent Publication No. 2004-71136, the upper halves of guide shafts 110, 120 are cut and bottomed holes 114, 124 are provided on cutting faces 116, 126 to bring adjustment screws 150, 160 into contact with bottom surfaces of holes 114, 124 for thinning the tilt adjustment device of an optical disc player. However, the diameter of guide shafts is commonly about 3 mm, therefore the height of adjustment screws 150, 160 is lowered by at most 2 mm or so and the heads of adjustment screws 150, 160 have no change in that they greatly protrude from the peripheral surface of guide shafts 110, 120 upward even if the upper halves are cut and the bottomed holes 114, 124 are further provided. Now, the adjustment screws 150, 160 greatly protrude from the peripheral surface of guide shafts 110, 120 upward even if drawings (FIGS. 2, 3, etc.) in Japanese Laid-Open Patent Publication No. 2004-71136 are seen. Namely, it is constructed to bring the adjustment screws 150, 160 into direct touch with the guide shafts 110, 120 to make tilt adjustment and the mounting positions of adjustment screws are limited, therefore there was a limit in thinning of the device to the extent that the device was concentrated to the shape of adjustment ends.

Even if the technique disclosed in Japanese Laid-Open Patent Publication No. 2002-352531 is applied to a tilt adjustment device of an optical pickup player described in Japanese Laid-Open Patent Publication No. 2004-71136, there is no change in that the adjustment screws 150, 160 of Japanese Laid-Open Patent Publication No. 2004-71136 were brought into direct touch with the guide shafts 110, 120 and the mounting positions of adjustment screws were limited, therefore there was a limit in thinning of the tilt adjustment device of the optical disc player.

The present invention was made in view of such a problem and aims at providing a pickup unit that can freely select mounting position of an adjustment screw for making the tilt adjustment of a pickup guide, i.e., tilt adjustment of a pickup according to peripheral conditions and facilitates miniaturization and thinning.

### SUMMARY OF THE INVENTION

In a pickup unit in which a pickup freely moves to and fro in the radial direction to a disc along a main guide and an auxiliary guide arranged on a unit substrate, the position of one end side of the main guide in the radial direction to the disc is fixed and the position of other end side in the tracking direction is adjustable, the end of main guide is energized in the tracking direction with a spring and the energizing force of the spring in the tracking direction is received by an adjusting plate.

One end of the adjusting plate is fixed to the unit substrate, the other end is brought in touch with the end of main guide to receive the energizing force in the tracking direction caused by the spring, the intermediate section is separated from the unit substrate, a through-hole is provided near the other end and a flexible part is provided near one end in the intermediate section, an adjusting screw is screwed with the unit substrate via the through-hole, and tilt adjustment is made by increasing or reducing the tightness of adjusting screw.

The flexible section may also be formed by notching a part of the intermediate section.

The adjusting plate may be divided between one end and the intermediate section and between the intermediate section and the other end by steps, respectively, and the heights of one end, intermediate section and the other end may be varied sequentially.

The adjusting plate is constructed such that one end of it is fixed to the unit substrate and the other end is brought into contact with the end of main guide and receives an energizing force in the tracking direction caused by the spring, the intermediate section of the adjusting plate has a flexible part near the one end and a through-hole near the other end, and the adjustment screw is screwed with the unit substrate via the through-hole, therefore the mounting position of adjustment screw can be freely selected according to peripheral conditions, thereby accomplishing miniaturization and thinning of the pickup unit.

The flexible part has a notch formed by notching a part of the intermediate section, enabling higher flexibility and its formation is also easy.

The adjusting plate can be made in the shape of providing steps between one end and intermediate section and between its intermediate section and the other end, respectively and mounted to a flat surface of the unit substrate.

### BRIEF DESCRIPTION OF THE DRAWINGS

The invention will become more apparent upon a reading of the following detailed description with reference to the accompanying drawings, in which:

FIG. 1 shows an oblique view of a disc player with a built-in pickup unit relating to the present invention.

FIG. 2 is a plan view showing a state of mounting the pickup unit to a lower frame of outer casing of the disc player shown in FIG. 1.

FIG. 3 is a rear view given by seeing the pickup unit built in the disc player shown in FIG. 1 from the rear side.

FIG. 4 is a partially enlarged side view given by seeing a relation between a first receiver and a first torsion spring from the axial direction of main guide.

FIG. 5 is a partially enlarged plan view showing the relation between the first torsion spring and receivers.

FIG. 6 is a partially enlarged rear view showing a relation between the adjusting plate and a second torsion spring.

FIG. 7 is a partially broken side view given by seeing a relation between the adjusting plate and the second torsion spring from the axial direction of main guide.

### DETAILED DESCRIPTION OF THE PREFERRED EMBODIMENT

The best embodiment for embodying a disc packing device of the present invention is described with reference to the drawings.

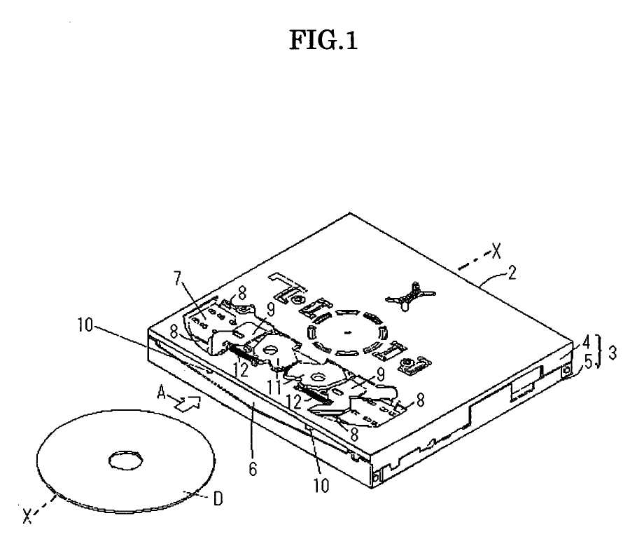

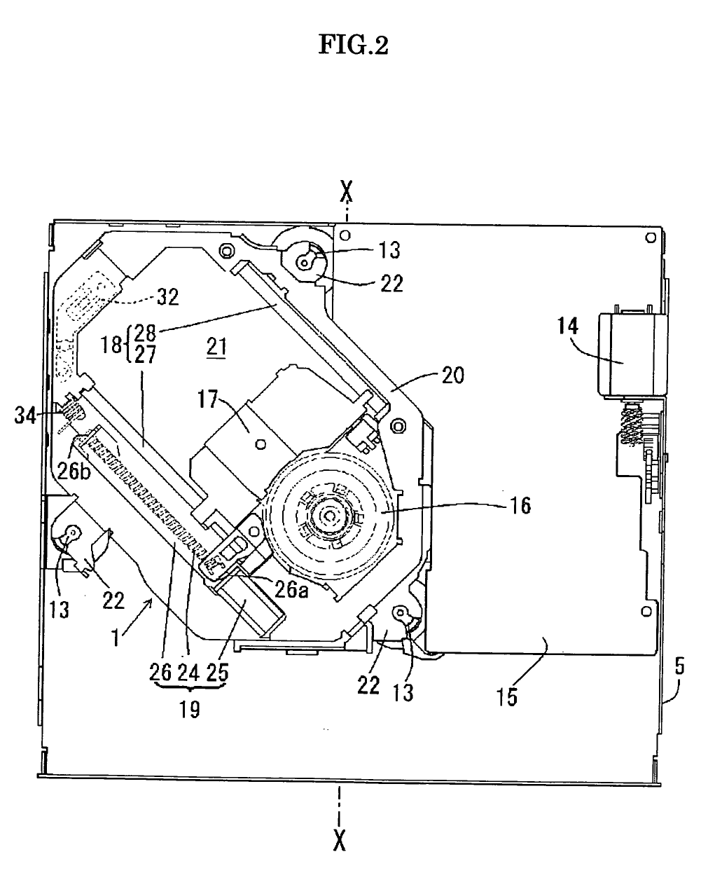

FIG. 1 shows a disc player 2 with a built-in pickup unit 1 (see FIG. 2). An outer casing 3 of disc player 2 comprises an upper frame 4 and a lower frame 5.

A disc insert port 6 is provided in a front plate of casing 3, and a disc D is inserted in the direction of arrow A from this insert port 6 along an axis X-X of the disc player 2. A part of the upper frame 4 close to the disc insert port 6 is partially dented, and this dented part is used as a guide plate 7. Openings 8 are provided at the front and rear edges of guide plate 7, the topside of guide plate 7 and the down-side of upper frame 4 are communicated in the horizontal direction.

A left-right pair of horizontal rotatable disc detecting members 9 are arranged on the top of guide plate 7, and both ends of each disc detecting member 9 extend along the downside of upper frame 4 through the openings 8.

In the disc detecting members 9, one end extended to the vicinity of disc insert port 6 is used as a disc contacting part 10. A left-right pair of interlocking gears 11 engaging with each other are arranged between the two disc detecting members 9. Each disc detecting member 9 is engaged with each interlocking gear 11 and the two disc detecting members 9 are synchronously rocked with left-right symmetry. Coil springs 12 are hung over between each interlocking gear 11 and the upper frame 4, and the two disc detecting members 9 are energized by rotation in such a direction that the left-right disc contacting parts 10 are drawn near to each other.

As shown in FIG. 2, the pickup unit 1 is mounted to the topside of lower frame 5 via multiple dampers 13 for vibration isolation, and an electronic circuit board 15 is mounted next to the pickup unit 1. A motor 14 for carrying the disc is mounted to the lateral plate of lower frame 5, and this motor 14 is controlled by a control circuit provided on the electronic circuit board 15.

The pickup unit 1 is constructed by mounting a turn table 16 with a built-in magnet, a pickup 17 for playing information recorded on a disc or recording information on a disc, a pickup support assembly 18 for supporting this pickup 17 with free to-and-fro movement in the radial direction to the disc D from the turn table 16 to a corner (left obliquely upper corner in the drawing) of the unit substrate 20, and a feed motor mechanism 19 for driving the pickup 17 to and fro, etc. onto the unit substrate 20.

The unit substrate 20 consists of a metal plate, has a large opening 21 at the center, and the turn table 16, pickup 17 and feed motor mechanism 19 are arranged nearly on the inner side of this large opening 21. Multiple mounting parts 22 are formed at the periphery of unit substrate 20 by bending work, and these mounting parts 22 are mounted to the lower frame 5 via the dampers 13.

The feed motor mechanism 19 is constructed by a feed motor 25 having a feed screw 24 and a motor support plate 26 for supporting them. The motor support plate 26 has a motor mounting piece 26a fixed to one end of feed motor 25 and a pivoting piece 26b for pivoting the tip of feed screw 24 and is mounted to the rear side of unit substrate 20.

The pickup support assembly 18 is constructed based on a main guide 27 and an auxiliary guide 28 consisting of stainless steel round rods.

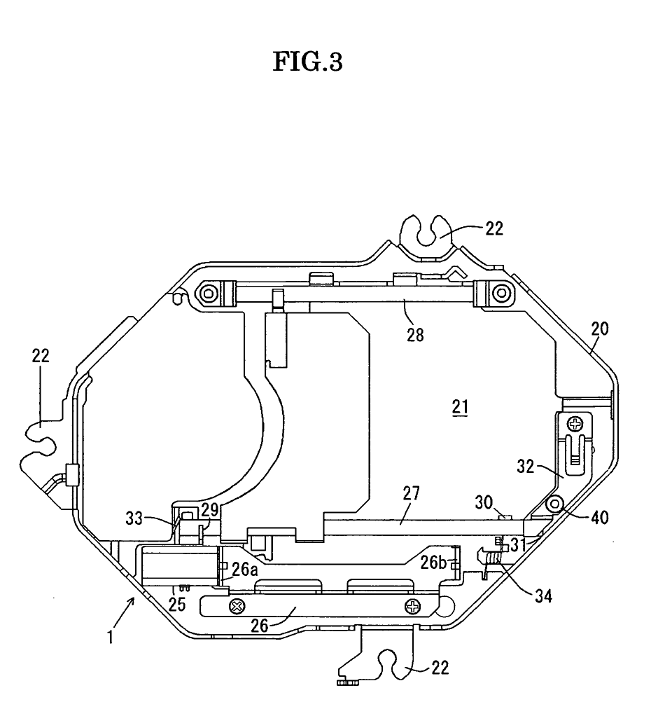

FIG. 3 is the rear view of pickup unit 1, and the unit substrate 20 has a first receiver 29 and a third receiver 30 formed by bending a part of edge of the large opening 21.

The edge of unit substrate 20 is bent upward, and a part of this bending portion is used as a second receiver 31.

A metal adjusting plate 32 is fixed to the rear face of unit substrate 20 with a screw.

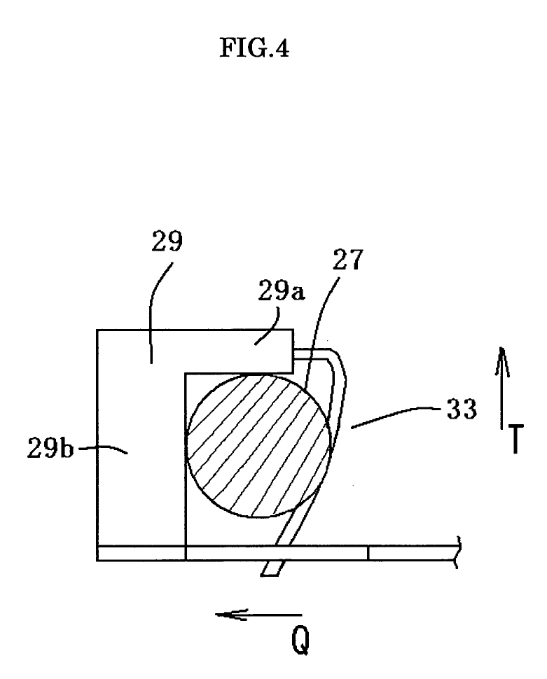

As shown in FIG. 4, the first receiver 29 is made into the shape of hook consisting of a horizontal piece 29a and a vertical piece 29b, and the periphery on one end side of main guide 27 is brought into contact with these pieces.

As shown in FIG. 3, the other edge of main guide 27 is brought into oblique touch with the second receiver 31, and the periphery of other end side of main guide 27 is brought into contact with the third receiver 30.

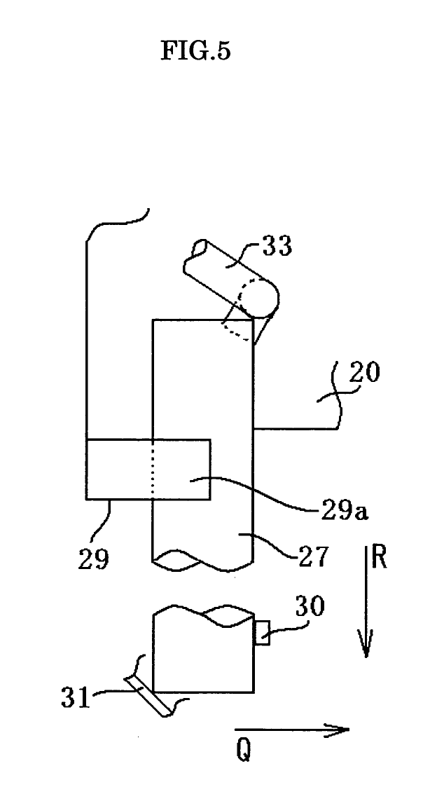

A first torsion spring 33 and a second torsion spring 34 are mounted to the rear face of unit substrate 20. As shown in FIG. 4 and FIG. 5, the first torsion spring 33 is in touch with one edge of main guide 27. Namely, the first torsion spring 33 is pressed to one edge of main guide 27 from right lower to left upper in FIG. 4 and from upper to lower in FIG. 5 and generates an upward component (tracking direction T to disc) and a leftward component (third direction Q) in FIG. 4 and a downward component (radial direction R to disc) in FIG. 5 at one edge of main guide 27 by these pressing forces. Then, the component in the tracking direction T is received by the horizontal piece 29a of the first receiver 29 and the component in the third direction Q is received by the vertical piece 29b as shown in FIG. 4 and the component in the radial direction R is received by the second receiver 31 as shown in FIG. 5. At this time, the other edge of main guide 27 is in oblique touch with the second receiver 31, therefore the component in the radial direction R caused by the first torsion spring 33 further generates a rightward (third direction) component in FIG. 5 in this touching part, and this component is received by the third receiver 30.

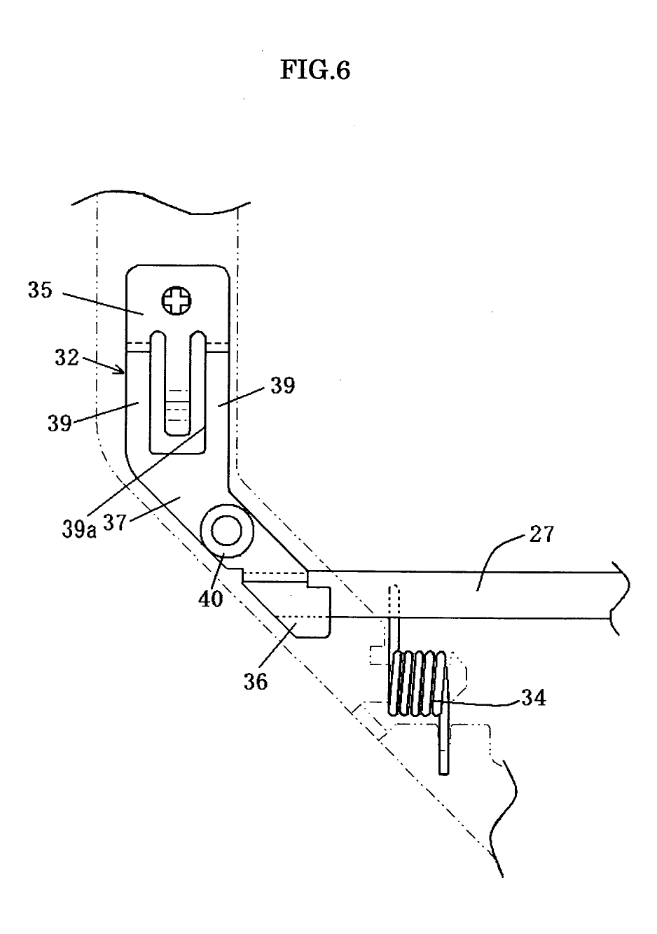

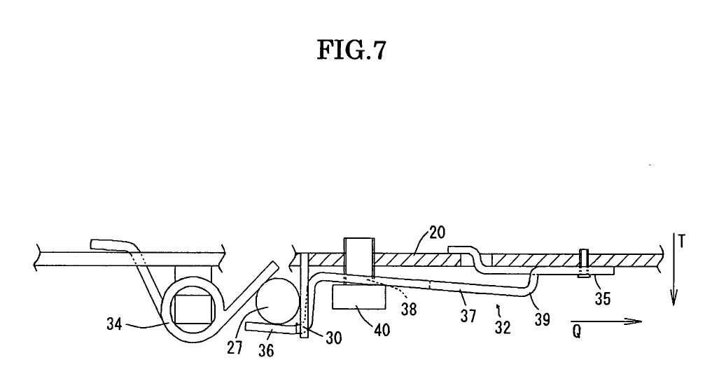

As shown in FIG. 6, the second torsion spring 34 is in touch with the periphery on the other end side of main guide 27. Namely, the second torsion spring 34 is pressed against the periphery of main guide 27 from left upper to right lower in FIG. 7 and generates a downward (tracking direction T to disc) component and a rightward (third direction Q) component in FIG. 7 on the other end side of main guide 27 by this pressing force. Then, the component in the third direction Q is received by the third receiver 30, and the component in the tracking direction T is received by the adjusting plate 32.

One end 35 of the adjusting plate 32 is fixed to the rear side of unit substrate 20, and its other end 36 is brought into contact with the periphery of other end of main guide 27 from below, the component in the tracking direction T based on the second torsion spring 34 is received by this other end 36, and an intermediate section 37 is apart from the unit substrate 20. This intermediate section 37 has a through-hole 38 near the other end and has a flexible part 39 which holds high flexibility by a notch 39a formed by notching a part near the one end 35.

Particularly, as shown in FIG. 7, the adjusting plate 32 is divided by steps between the one end 35 and the intermediate section 37 and between the intermediate section 37 and the other end 36 by steps, respectively and is so formed that the height from the one end 35 to the other end 36 decreases sequentially, i.e., goes away from the unit substrate 20 sequentially. Moreover, the intermediate section 37 is set to be comparatively long, therefore the flexible part 39 is easier to flex in cooperation with the construction of notch 39a.

The size of unit substrate 20 is made as small as possible and a large opening 21 is provided, therefore the position and area for mounting the adjusting plate 32 are limited, however, as shown in FIG. 4, it can be set to any shape in conformity with the shape of unit substrate 20 and can be easily mounted to the unit substrate 20.

In FIG. 7, 40 is an adjustment screw forming an adjustment screwing means, and this adjustment screw 40 is screwed from the rear side of unit substrate 20 via the through-hole 38. The position of adjustment screw 40 can also be freely selected according to peripheral conditions, such as shape of unit substrate 20, etc.

Like FIG. 2, both ends of the auxiliary guide 28 are mounted to the rear face of unit substrate 20.

In the above construction, the tilt adjustment of pickup 17 is made by increasing or reducing the tightness of adjustment screw 40.

Namely, if the adjustment screw 40 is fastened against the component of second torsion spring 34 in the tracking direction T, the other end of main guide 27 rises, conversely, if the adjustment screw 40 is loosened, the other end of main guide 27 falls.

In the embodiment described above, the adjusting plate 32 is made into the shape of providing steps between the one end 35 and the intermediate section 37 and between the intermediate section 37 and the other end 36, respectively, therefore the intermediate section 37 is apart from the unit substrate 20 even if the adjusting plate 32 is mounted to a flat surface of unit substrate 20. For this step construction, however, when the one end 35 of adjusting plate 32 is fixed to the rear face side unit substrate 20, the other end 36 is in touch with the main guide 27 and receives an energizing force in the tracking direction caused by the second torsion spring 34, the intermediate section 37 may be apart from the unit substrate 20, therefore the steps are not always necessary depending on what is the shape of unit substrate 20.

The first spring 33 and the second spring 34 are used as torsion springs, and they can also be made into plate springs or other springs. Moreover, the other end side of main guide 27 is energized simultaneously in the tracking direction and the third direction by the single second torsion spring 34, but respective springs may also be used for each direction of energization.

What is claimed is:

1. A pickup unit including a pickup 17, a unit substrate 20, a main guide 27 and an auxiliary guide 28, both guides being arranged on the unit substrate, the pickup being guided with free to-and-fro movement to a disc D in a tracking direction to the disc by these two guides, the position of one end side of the main guide in the tracking direction to the disc being fixed and the position of the other end side being adjustable
in which
the pickup unit further comprises
a spring 34 for energizing the end of main guide in the tracking direction,
an adjusting plate 32,
said adjusting plate having
one end 35 fixed to the unit substrate,
other end 36 being in touch with the end of main guide and receiving an energizing force of the spring in the tracking direction and
an intermediate section 37 with a through-hole 38 formed near the other end and a flexible part 39 provided near the one end and arranged apart from the unit substrate, and
adjusting screw mean 40 screwed from the rear face side with the unit substrate via the through-hole.

2. The pickup unit according to claim 1 wherein the flexible part 39 includes a notch 39a formed by notching a part of the intermediate section 37.

3. The pickup unit according to claim 1 wherein the adjusting plate is made by dividing it between the one end and the intermediate section and between the intermediate section and the other end by steps, respectively and sequentially varying heights of the one end, the intermediate section and the other end.
